(19) United States
(12) Patent Application Publication
(10) Pub. No.: US 2026/0021657 A1
(43) Pub. Date: Jan. 22, 2026

(54) PRINTING PLATE, DISPLAY DEVICE AND METHOD OF MANUFACTURING COVER WINDOW

(71) Applicant: Samsung Display Co., Ltd., Yongin-Si (KR)

(72) Inventor: Junyoung KIM, Yongin-si (KR)

(21) Appl. No.: 19/195,280

(22) Filed: Apr. 30, 2025

(30) Foreign Application Priority Data
Jul. 22, 2024 (KR) 10-2024-0096492

(51) Int. Cl. B41F 17/00

(52) U.S. Cl. CPC B41F 17/001; B41F 17/006

(57) ABSTRACT

A printing plate according to an embodiment includes a base substrate having a concave part sunken from a substrate surface, wherein the concave part includes a first area that is sunken by a first depth from the substrate surface of the base substrate and a second area that is sunken by a second depth from a surface of the first area. The printing plate may be used for pad printing.

### CROSS-REFERENCE TO RELATED APPLICATION

This application claims priority to and the benefit of Korean Patent Application No. 10-2024-0096492 filed at the Korean Intellectual Property Office on Jul. 22, 2024, the entire content of which is incorporated herein by reference.

### BACKGROUND

### (a) Field

The present disclosure relates to a printing plate, a display device, and a method of manufacturing a cover window, and more specifically, to a printing plate that can be used in pad printing, a method of manufacturing a cover window using the same, and a display device including the cover window.

### (b) Description of the Related Art

Pad printing is a printing method that uses a pad to indirectly transfer ink from a printing plate to a print object. For example, printing is performed by injecting ink into a printing plate, allowing the ink injected into the printing plate to get absorbed into a pad, and then transferring the ink absorbed into the pad to a product.

Products printed by pad printing or the like may have an engraving formed, for example, using a laser or the like. In areas where ink is absorbed and printed on a product, such as through pad printing, the printed area may be partially cut out, for example, through laser engraving, to form a pattern such as a quick response (QR) code. However, when forming the QR code through laser engraving or the like, the area where the ink has been cut may be visible from the outside due to reduced thickness of the ink layer.

### SUMMARY

The embodiments attempt to provide a printing plate used in pad printing capable of reducing the visibility of the cut portion from the outside even when the printing area is partially cut off.

The embodiments attempt to provide a method of manufacturing a cover window including a printing area capable of reducing visibility of the cut portion from the outside even when the printing area is partially cut.

The embodiments attempt to provide a display device including a cover window manufactured by a method of manufacturing a cover window.

A printing plate according to an embodiment includes a base substrate having a concave part sunken from a substrate surface, wherein the concave part includes a first area that is sunken by a first depth from the substrate surface of the base substrate and a second area that is sunken by a second depth from a surface of the first area. The printing plate may be used for pad printing.

The base substrate may include a substrate central part and a substrate peripheral part surrounding the substrate central part, and the concave part may be disposed in the substrate peripheral part without extending into the substrate central part.

The first area may be disposed in the substrate peripheral part and surround the substrate central part.

The first area may have a width and an imaginary centerline extending through midpoints of the width, further comprising a concave central part including the imaginary centerline and a predetermined distance to either side of the centerline in the first area and a concave peripheral part surrounding the concave central part, and the second area may be disposed in the concave central part.

The second area may have a quadrangular shape.

The first depth of the first area from the substrate surface may be greater than the second depth of the second area from the surface of the first area.

The second depth may be at least 4 μm and no greater than 10 μm.

A electronic device according to an embodiment includes a display device including a display panel including a display area in which an image is displayed, and a cover window including a window part covering the display area and a printing part disposed at the edge of the window part.

The printing part includes an ink layer, including a first ink layer and a second ink layer disposed on the first ink layer and having a smaller face area than the first ink layer, and an identification mark disposed on an identification layer formed in the ink layer, wherein the identification mark has a concavo-convex pattern engraved on the identification layer and the second ink layer.

The thickness of the second ink layer may be smaller than the thickness of the first ink layer.

The identification layer may have a smaller face area than the first ink layer.

The identification mark may be disposed in an area where the second ink layer and the identification layer overlap.

The depth at any portion of the concavo-convex pattern may be smaller than the sum of the thickness of the first ink layer, the thickness of the second ink layer, and the thickness of the identification layer.

A method of manufacturing a cover window according to an embodiment includes preparing a printing plate, including a base substrate having a concave part sunken from a substrate surface, wherein the concave part includes a first area that is sunken by a first depth from the substrate surface of the base substrate and a second area that is sunken by a second depth from the surface of the first area. The method includes forming an ink layer by injecting a first ink into the printing plate and transferring the injected first ink to a window substrate using a pad. The method includes forming an identification layer on the ink layer. The method includes forming an identification mark by cutting an area where the ink layer and the identification layer overlap in a concavo-convex pattern.

The forming of the ink layer may include injecting the ink into the first area and the second area of the concave part.

The forming of the ink layer may include forming a first ink layer and a second ink layer with the first ink injected into the first area and the second area.

The forming of the ink layer may include forming the second ink layer to be thinner than the first ink layer.

The forming of the identification layer may include printing identification ink on the second ink layer having a smaller face area than the first ink layer.

The forming of the ink layer may include injecting the first ink into the concave part, transferring the first ink to the window substrate and drying the first ink, injecting the second ink into the concave part, and transferring the second ink to the dried first ink and drying the second ink.

The forming of the identification mark may include forming the concavo-convex pattern to have a depth smaller than the sum of the thickness of the ink layer and the thickness of the identification layer.

The forming of the identification mark may include forming the concavo-convex pattern to correspond to a bar code or a quick response (QR) code. According to embodiments, even if a pattern such as an identification code is formed by cutting after pad printing, the ink of the printed portion may maintain a certain thickness. Accordingly, even if cutting is performed through laser engraving or the like, the cut portion may not be visible from the outside.

### BRIEF DESCRIPTION OF THE DRAWINGS

FIGS. 1 and 2 are a top plan view and a cross-sectional view of a printing plate according to an embodiment.

FIG. 3 is an enlarged top plan view of area B′ of FIG. 1.

FIG. 4 is a cross-sectional view of a concave part of a printing plate according to an embodiment.

FIG. 5 is a process flowchart illustrating a method of manufacturing a cover window according to an embodiment.

FIG. 6 is a schematic view illustrating a method of manufacturing a cover window according to an embodiment.

FIG. 7 is a cross-sectional view of a window printed according to a method of manufacturing a cover window according to an embodiment.

FIG. 8 is a cross-sectional view of a printed area according to a method of manufacturing a cover window according to an embodiment.

FIG. 9 is a top plan view and a cross-sectional view of a cover window according to an embodiment.

FIG. 10 is a cross-sectional view of a cover window according to an embodiment.

FIG. 11 is a perspective view of a display device according to an embodiment.

FIG. 12 is an exploded perspective view of a display device according to an embodiment.

FIG. 13 is a block diagram of an electronic device according to an embodiment.

FIGS. 14 to 16 are schematic diagrams of electronic devices according to some embodiments.

### DETAILED DESCRIPTION OF THE EMBODIMENTS

The present disclosure will be described in detail hereinafter with reference to the accompanying drawings, in which embodiments of the present disclosure are shown. As those skilled in the art would realize, the described embodiments may be modified in various ways, all without departing from the spirit or scope of the present disclosure.

The drawings and description are to be regarded as illustrative in nature and not restrictive, and like reference numerals designate like elements throughout the specification.

Size and thickness of each constituent element in the drawings are arbitrarily illustrated for better understanding and ease of description, but the following embodiments are not limited thereto. In the drawings, the thickness of layers and regions are exaggerated for clarity. In the drawings, the thickness of some layers and regions may be exaggerated for ease of description.

It should be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be disposed above or below the reference element, and it is not necessarily referred to as being disposed “on” or “above” in a direction opposite to gravity.

Unless explicitly stated to the contrary, the word “comprise,” and variations such as “comprises” and “comprising,” should be understood to imply the inclusion of stated elements but not the exclusion of any other elements.

The phrase “on a plane” means a view from a position above the object (e.g., from the top), and the phrase “on a cross-section” means a view of a cross-section of the object which is vertically cut from the side.

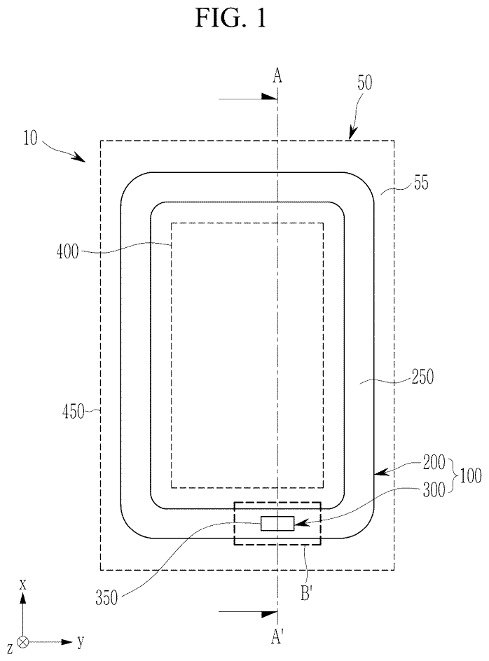

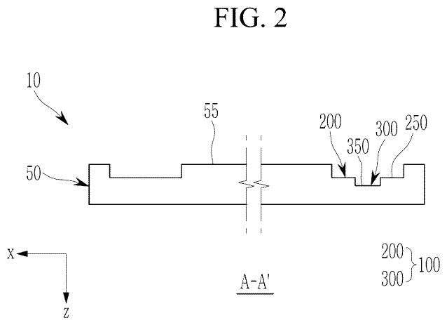

FIG. 1 is a schematic top plan view of a printing plate according to an embodiment. FIG. 2 is a cross-sectional view of a printing plate taken along line A-A′ of FIG. 1 in the thickness direction. For example, the printing plate may be a printing plate of pad printing for forming a printing layer of a blocking area of a cover window included in a display device.

Referring to FIGS. 1 and 2, a printing plate 10 may include a base substrate 50 and a concave part 100 sunken from a substrate surface 55 of the base substrate 50. The substrate surface 55 of the base substrate 50 refers to the surface of the base substrate 50 when viewed on an x-y plane defined by the x-axis and the y-axis.

In an embodiment, the concave part 100 disposed on the base substrate 50 may include a first area 200 that is sunken or recessed with respect to the substrate surface 55 of the base substrate 50, and a second area 300 that is sunken or recessed with respect to a surface 250 of the first area 200. For example, the concave part 100 may be divided into the first area 200 and the second area 300. The concave part 100 may be a sunken area having a constant depth in the z-axis direction that is perpendicular to the x-axis and the y-axis. The concave part 100 is sunken or recessed with respect to the substrate surface 55 of the base substrate 50.

The first area 200 may refer to a portion that is sunken or recessed by a predetermined depth from the substrate surface 55. The second area 300 may refer to a portion that is sunken or recessed by a predetermined depth from the surface 250 of the first area 200. The first area 200 and the second area 300 of the concave part 100 formed on the base substrate 50 may be provided as areas that receive ink during the printing process.

The base substrate 50 may include a substrate central part 400 and a substrate peripheral part 450 surrounding the substrate central part 400. For example, the substrate central part 400 may refer to an area that includes the center of the base substrate 50 and has a predetermined distance from the center. For example, the substrate peripheral part 450 may refer to an area from the substrate central part 400 to each side of the base substrate 50.

The base substrate 50 may include the substrate central part 400 and the substrate peripheral part 450 surrounding the substrate central part 400. The substrate central part 400 and the substrate peripheral part 450 may be in contact with each other. When the base substrate 50 is viewed on the x-y plane, the base substrate 50 may be divided into the substrate central part 400 and the substrate peripheral part 450.

In an embodiment, part of the concave part 100 may be disposed in the substrate peripheral part 450. The concave part 100 may have an outline that is similar to the outline of the base substrate 50 with a margin adjacent to each side of the base substrate 50. The concave part 100 may surround the substrate central part 400. For example, as depicted in FIG. 1, the concave part 100 may surround the substrate central part 400 of the base substrate 50 while leaving a margin between the edges of the concave part 100 and each side of the base substrate 50. Accordingly, when the concave part 100 is provided as an ink supply area and is printed, for example, on a cover window, printing may be performed along each side of the cover window.

The base substrate 50 may have a quadrangular shape. When the base substrate 50 has a quadrangular shape, the substrate central part 400 may refer to a quadrangular-shaped area that includes the center of the base substrate 50 and extending a predetermined distance from the center. The concave part 100 may be formed such that its edges surround the substrate central part 400.

The concave part 100 formed in the base substrate 50 may have a shape that substantially matches that of the base substrate 50 but with curved corners.

For example, when the concave part 100 extends along the edges of the substrate peripheral part 450 of the base substrate 50, the corner of the belt shape may be curved. For example, when printing on a cover window having a quadrangular shape with curved corners using the printing plate 10, the concave part 100 may be formed to match the shape of the cover window. Accordingly, printing may be performed without wasting ink at the corners of the cover window.

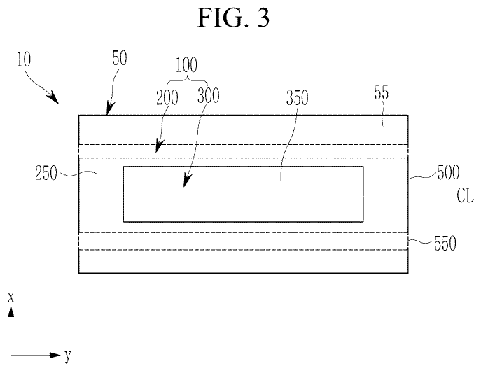

FIG. 3 is an enlarged top plan view of an area B′ of FIG. 1. The area B′ is an area that includes a portion of the base substrate 50 outside the concave part 100 where a portion of the first area 200 and the second area 300 are formed. The area B′ may include a portion of the substrate surface 55, a portion of the surface 250 of the first area, and a surface of the second area 300 when viewed on the x-y plane defined by the x-axis and the y-axis.

In an embodiment, the first area 200 may include a concave central part 500 and a concave peripheral part 550 adjacent to the concave central part 500.

The concave central part 500 includes a center line CL extending in the y-direction and including a midpoint of the width of the concave central part 500, the width measured in the x-direction in the case depicted in FIG. 3. The “width,” as used herein, may refer to a distance between two opposing edges. Where the opposing edges are parallel, the width may be measured in a direction that is perpendicular to the opposing edges.

The concave central part 500 includes the center or center line CL of the first area 200 and an area having a predetermined distance from the center or center line CL. When the first area 200 has, for example, a circular or polygonal shape, the concave central part 500 may include the center or the center line of the first area 200 and an area within a predetermined distance from the center.

The second area 300 may be disposed in the concave central part 500 of the first area 200. The second area 300 may be formed to be surrounded by the concave peripheral part 550 of the first area 200. The second area 300 may be formed in a circular or polygonal shape in the concave central part 500 of the first area 200, and may be positioned between two sections of the concave peripheral part 550 in the first area 200.

In an embodiment, the second area 300 may have a quadrangular planar shape. The second area 300 may have a quadrangular planar shape such as a square, rectangle, trapezoid, or rhombus. The second area 300 may be sunk deeper from the substrate surface 55 than the first area 200. Accordingly, when printing is performed through the printing plate 10, the thickness of the quadrangular-shaped printed portion formed by the second area 300 may be greater than the thickness of the adjacent portions.

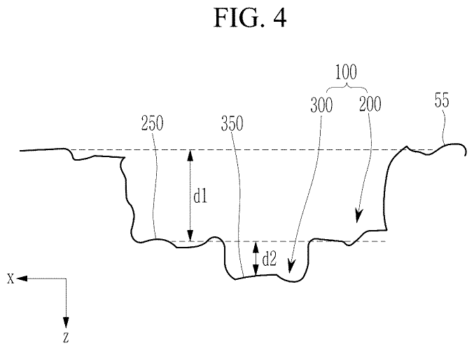

FIG. 4 is a cross-sectional view depicting a concave part of a printing plate according to an embodiment. The cross-sectional view schematically illustrates the depths of different sections of the concave part of an actually manufactured printing plate.

Referring to FIG. 4, the first area 200 may have a first depth d1, and the second area 300 may have a second depth d2. The first depth d1 may refer to the depth in the z-axis direction from the substrate surface 55 to the surface 250 of the first area. The second depth d2 may refer to the depth in the z-axis direction from the surface 250 of the first area 200 to the surface 350 of the second area 300.

In an embodiment, the first area 200 may have a depth of 13 μm to 20 μm, 15 μm to 20 μm, 15 μm to 18 μm, or 16 μm to 18 μm from the substrate surface 55. For example, the first depth d1 from the substrate surface 55 to the surface 250 of the first area may be within the above range. The first area 200 of the concave part 100 may be defined by forming a recess on the substrate surface 55 having the above-defined depth.

During the manufacturing process of the printing plate 10, fine concavo-convex pattern may be formed on the substrate surface 55 and the surface 250 of the first area. In this case, the first depth d1, which is the depth from the substrate surface 55 to the surface 250 of the first area, may refer to the difference between the average altitude of the entire substrate surface 55 to the average altitude of the entire surface 250 of the first area. The average altitude of the entire substrate surface 55 may refer to the average of the altitudes of the fine concavo-convex pattern formed on the base substrate surface 55 at different points. The average altitude of the surface 250 of the first area 200 may refer to the average of the altitudes of the fine concavo-convex pattern formed on the surface 250 of the first area at different points.

The first depth d1, which is the depth from the substrate surface 55 to the surface 250 of the first area, may be substantially constant. For example, although FIG. 4 depicts the surface 250 as being uneven, the variation in the depth measured between any two points of the surface 250 may be within 1 μm, within 800 nm, or within 500 nm. Accordingly, when pad printing the ink provided in the first area 200, the variation in the thickness of the printed area may be small. Therefore, color differences due to differences in the thickness of the printed area may be reduced.

In an embodiment, the first depth d1, which is the depth from the substrate surface 55 to the surface 250 of the first area 200, may be deeper than the second depth d2, which is the depth from the surface 250 of the first area to the surface 350 of the second area. For example, the first area 200 may be defined by forming a recess having the first depth d1 from the substrate surface 55. The second area 300 may be defined by forming a recess having the second depth d2 smaller than the first depth d1 from the surface 250 of the first area.

In an embodiment, the second area 300 may have a depth of 4 μm to 10 μm, 4 μm to 8 μm, 5 μm to 8 μm, or 5 μm to 7 μm from the surface 250 of the first area 200. For example, the second depth d2, which is the depth from the surface 250 of the first area 200 to the surface 350 of the second area 300, may be within the above range. The second area 300 of the concave part 100 may be defined by forming a recess having a depth within the above range on the surface 250 of the first area 200.

During the manufacturing process of the printing plate 10, fine concavo-convex pattern may be formed on the surface 250 of the first area 200 and the surface 350 of the second area 300. In this case, the second depth d2, which is the depth from the surface 250 of the first area 200 to the surface 350 of the second area 300, may refer to the difference between the average altitude of the surface 250 of the first area 200 to the average altitude of the surface 350 of the second area 300. The average altitude of the surface 250 of the first area may refer to the average of the varying altitudes of the fine concavo-convex pattern formed on the surface 250 of the first area 200. The average altitude of the surface 350 of the second area 300 may refer to the average of the altitudes of the fine concavo-convex pattern formed on the surface 350 at various points of the second area 300.

The second depth d2, which is the depth from the surface 250 of the first area to the surface 350 of the second area, may be substantially constant. For example, the variation in the second depth d2 measured at any two points may be within 1 μm, within 800 nm, or within 500 nm. Accordingly, when pad printing the ink provided in the second area 300, the variation in the thickness of the printed area may be reduced. Therefore, the color difference due to the thickness difference of the printed area may be reduced.

The above-described printing plate 10 may be used for pad printing. For example, printing may be performed by injecting ink into the concave part 100 and transferring the ink to a product such as a window through the pad. Below, a method of manufacturing a cover window by performing printing on the cover window using the above-described printing plate 10 will be described.

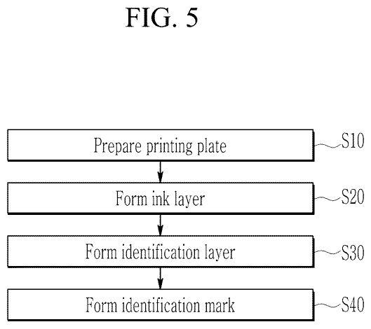

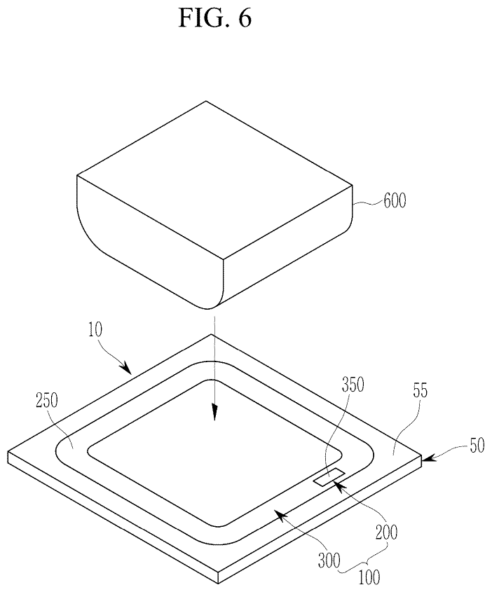

FIG. 5 is a schematic process flowchart illustrating a method of manufacturing a cover window according to an embodiment. FIG. 6 is a schematic view illustrating a method of manufacturing a cover window according to an embodiment.

Referring to FIGS. 5 and 6, the printing plate 10 including the base substrate 50 having the concave part 100 sunken from the substrate surface 55 may be prepared (S10). The concave part 100 may include the first area 200 that is concave from the substrate surface 55 of the base substrate 50 and the second area 300 that is more concave from the surface of the first area 200. The printing plate 10 may be a printing plate described with reference to FIGS. 1 to 4 above.

In an embodiment, the first ink may be injected into the printing plate 10 and the injected first ink may be transferred to a window substrate using a pad 600 to form an ink layer (S20).

In an embodiment, the first ink may be injected into the first area 200 and the second area 300 of the concave part 100 of the printing plate 10. For example, the first ink may be provided to the printing plate 10 by injecting the first ink into the concave part 100 including the first area 200 and the second area 300 formed on the printing plate 10. The method of injecting the first ink into the concave part 100 is not limited.

The first ink may be provided to the printing plate 10 by injecting the first ink into the concave part 100 so that the first ink fills to a level lower than the substrate surface 55 of the base substrate 50 of the printing plate 10. In the case where the first ink is filled to a level lower than the substrate surface 55 of the base substrate 50, the first ink is contained in the concave part 100 and prevented from being transferred or absorbed to another portion of the pad 600 during the process of the pad 600 absorbing the first ink. For example, in the case where the first ink is contained in the concave part 100, the first ink may fill the entire second area 300, and the first ink may fill the first area 200 to a predetermined level.

The first ink provided on the printing plate may be transferred to the pad 600, as depicted in FIG. 6. The first ink is absorbed into the pad 600 and thus be transferred from the concave part 100 to the pad 600. For example, the printing plate 10 injected with the first ink may be in a fixed position, and the pad 600 may be moved in the direction of the n FIG. 6 to transfer the first ink to the pad 600.

The pad 600 may be formed of a material capable of absorbing ink. For example, the pad 600 may be formed of silicone, urethane, natural rubber, synthetic rubber, or the like. Accordingly, the adhesion of the first ink to the pad 600 may be improved, and the amount of residual ink that is not transferred during the process of transferring the first ink to the pad 600 may be reduced.

The first ink may be transferred from the pad 600 to a window substrate to form an ink layer. The first ink may be dried to complete printing. The window substrate may be a window substrate of a cover window disposed on the front surface of the display device.

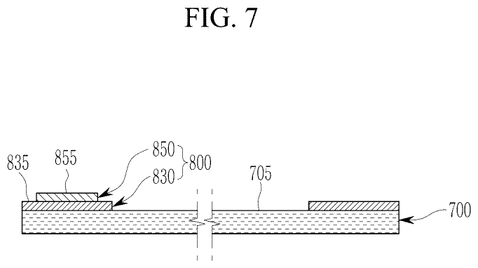

FIG. 7 is a cross-sectional view of a window printed according to a method of manufacturing a cover window according to an embodiment.

Referring to FIGS. 5 to 7, the first ink transferred to a window substrate 700 may form an ink layer 800 including a first ink layer 830 and a second ink layer 850.

According to an embodiment, the first ink layer 830 and the second ink layer 850 may be formed with the first ink injected into the first area 200 and the second area 300 of the printing plate 10. The first ink transferred to the window substrate 700 may form the ink layer 800 including the first ink layer 830 and the second ink layer 850 disposed on the first ink layer 830. The first ink layer 830 may be in an area corresponding to the first area 200, and the second ink layer 850 may be in an area corresponding to the second area 300.

When the first ink is transferred to the pad 600, the first ink may be transferred to a shallow level of the pad 600 corresponding to a portion where only the first area 200 is formed. The area of the pad 600 corresponding to the second area 300 may have the first ink transferred to a deeper level than the portion corresponding to the first area 200. Accordingly, the first ink transferred to the pad 600 may include areas having two different levels, and this translates to the printed area including two areas having different thicknesses after the ink is transferred to the window substrate 700. The two areas having different thicknesses may be an area where only the first ink layer 830 is formed, and an area where the first ink layer 830 and the second ink layer 850 are formed.

For example, the first ink injected into the first area 200 and the second area 300 may be transferred to the pad 600 and absorbed in a shape corresponding to the concave part 100 of the printing plate 10. When the absorbed first ink is transferred to the window substrate 700, the first ink injected into the second area 300 may be absorbed onto the window substrate 700. In the first area 200, the first ink injected into the first area 200 may be absorbed onto the window substrate 700.

The thickness of the first ink absorbed on the pad 600 may be thinner in the first area 200 than in the second area 300. From the pad 600, the thin portion of the first ink may gravitate toward the window substrate 700 and be absorbed onto the window substrate 700.

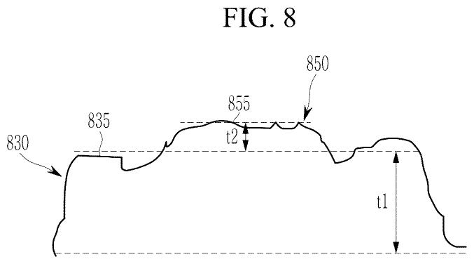

FIG. 8 is a cross-sectional view of a printed area of a cover window manufactured according to a method of manufacturing a cover window according to an embodiment of the present disclosure, and is a cross-sectional view schematically illustrating the thickness of a printed area of a manufactured window cover.

Referring to FIG. 8, the first ink layer 830 may have a first thickness t1, and the second ink layer 850 may have a second thickness t2. The first thickness t1 may refer to an average thickness from a surface 705 of the window substrate of the first ink layer 830 to a surface 835 of the first ink layer. The second thickness t2 may refer to an average thickness from the surface 835 of the first ink layer to a surface 855 of the second ink layer.

In an embodiment, the second thickness t2 may be smaller than the first thickness t1. Accordingly, the second ink layer 850 may be stably disposed on the first ink layer 830.

In an embodiment, the first ink layer 830 may have a thickness t1 of 4 μm to 20 μm, or 4 μm to 18 μm from the surface 705 of the window substrate. The first ink layer 830 may have a thickness t1 of 4 μm to 10 μm, 4 μm to 8 μm, 5 μm to 8 μm, or 6 μm to 8 μm from the surface 705 of the window substrate. The first ink layer 830 may have a thickness t1 of 13 μm to 20 μm, 15 μm to 20 μm, 15 μm to 18 μm, or 16 μm to 18 μm from the surface 705 of the window substrate.

As the first ink is transferred to the surface 705 of the window substrate, the thickness of the first ink layer 830 may not be constant throughout the different points of the first ink layer 830. For example, due to the surface tension of the first ink, the center of the first ink layer 830 may be at a different altitude (e.g., lower) than the outer portion. As used herein, the first thickness t1 may refer to an average thickness measured from the surface 705 of the window substrate to the surface 835 of the first ink layer for the entire first ink layer 830. The “first ink” and “second ink” may have the same composition.

In an embodiment, the second ink layer 850 may have a thickness t2 from the surface 835 of the first ink layer of 2 μm to 10 μm, 2 μm to 8 μm, 2 μm to 7 μm, 2 μm to 5 μm, 3 μm to 5 μm, or 3 μm to 4 μm.

As the first ink is transferred to the surface 705 of the window substrate, the thickness of the second ink layer 850 may not be constant throughout the different points of the second ink layer 850. For example, due to the cohesion of the second ink, the thickness of the center of the second ink layer 850 may be different (e.g., greater) than the thickness at the outer portion. In this case, the second thickness t2 may mean an average thickness from the surface 835 of the first ink layer to the surface 855 of the second ink layer taken over the entire area of the second ink layer 850.

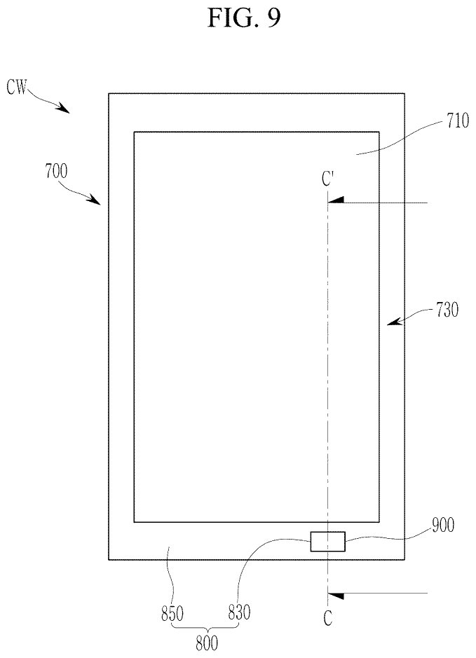

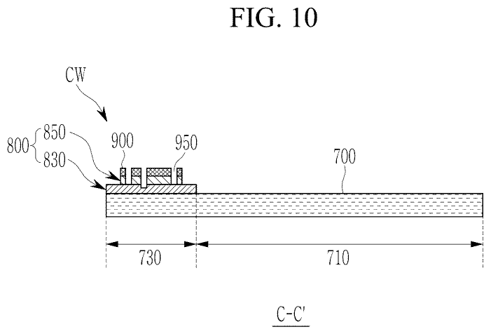

FIGS. 9 and 10 are a top plan view and a cross-sectional view, respectively, of a cover window according to an embodiment. FIG. 10 is a cross-sectional view taken along line C-C′ of FIG. 9 in the thickness direction. In an embodiment, the window substrate 700 of a cover window CW may include a window part 710 and a printing part 730. The window part 710 may refer to an area where printing is not actually performed. The printing part 730 may refer to an area where ink is printed through pad printing. The center of the window substrate 700 may be provided as the window part 710. A margin of a predetermined width from each edge of the window substrate 700 may be provided as the printing part 730. For example, the printing part 730 may be an area surrounding the window part 710.

In an embodiment, the first ink layer 830 may be formed adjacent to each side of the window substrate 700 on the margin of the window substrate 700. The first ink layer 830 may be formed along the periphery of the window substrate 700. The first ink layer 830 may be formed on the printing part 730 of the window substrate 700 to surround the window part 710. For example, the first ink layer 830 may be formed on the cover window CW of the display device, and may be formed adjacent to each side of the cover window CW to define a blocking area surrounding the cover window CW.

The second ink layer 850 may be formed on the first ink layer 830 formed on the printing part 730 of the window substrate 700. The second ink layer 850 may have a substantially quadrangular shape. The second ink layer 850 may be formed on the first ink layer 830 in a quadrangular shape, such as a square, rectangle, trapezoid, or rhombus.

In an embodiment, forming the ink layer 800 may include a first process of injecting the first ink into the concave part 100 transferring the first ink to the window substrate 700, and drying the first ink, and a second process of injecting the second ink into the concave part 100, transferring the second ink to the dried first ink, and drying the second ink. For example, the second ink may be transferred onto the window substrate 700 on which the first ink has been transferred according to the method described above to form the ink layer 800.

The first ink may be dried before transferring the second ink onto the first ink. Drying the first ink ensures that the first ink and the second ink may be laminated without mixing.

After transferring the second ink, the second ink may be dried. Accordingly, even if an identification layer 900 (described below in reference to FIG. 10) is formed on the ink layer 800 that includes the first ink and the second ink, the ink layer 800 and the identification layer 900 may not be mixed together.

The process for printing the second ink may be the same as the process for printing the first ink described above. For example, the second ink may be provided to the concave part 100 of the printing plate 10. The second ink provided in the concave part 100 of the printing plate 10 may be transferred to the pad 600. The second ink transferred to the pad 600 may be transferred to the window substrate 700 and dried to print the second ink.

The area of the window substrate 700 to which the second ink is transferred may overlap the area that received the first ink. In the process of transferring the first ink to the window substrate 700, some of the first ink may not be printed on the window substrate 700 either because some of the first ink remains on the printing plate without being transferred to the pad 600 or because the first ink adsorbed to the pad 600 and did not transfer to the window substrate 700. In this case, the thickness of the first ink printed on the window substrate 700 may be reduced. Accordingly, even if a QR code is formed, for example by laser engraving, in an area where the first ink layer 830 and the second ink layer 850 overlap, the QR code (or any other identification mark) may be visible from the outside.

To reduce the visibility of the QR code from the outside, the thickness of the ink layer may be increased by printing the second ink on the first ink is printed. Accordingly, the area where the first ink layer 830 and the second ink layer 850 overlap may have sufficient thickness such that even if an identification mark 950 described below is formed, the identification mark 950 may not be visible from the outside.

Printing the first ink may be performed by one-color printing. Printing the second ink may be performed by two-color printing. For example, the first ink may be black ink. For example, the second ink may be an ink including two colors. Accordingly, as the thickness of the ink layer 800 printed on the window substrate 700 increases, the surface of the ink layer 800 may be formed in various colors.

In an embodiment, the identification layer 900 may be formed on the ink layer 800 (S30). For example, the second ink layer 850 may be disposed on the first ink layer 830, and the identification layer 900 may be disposed on the second ink layer 850.

As illustrated in FIG. 10, the identification layer 900 may be formed by printing identification ink on the second ink layer 850 to have a smaller face area than the first ink layer 830. The identification layer 900 may be formed on the second ink layer 850 to have a pattern and face area substantially the same as those of the second ink layer 850. In some embodiments, the identification layer 900 may have an area smaller than the face area of the second ink layer 850. The “face area,” as used herein, refers to the size of the area in the x-y plane. Accordingly, even if the identification mark 950 having a concavo-convex pattern is formed by etching the identification layer 900, the relative distance between the concave part of the identification mark 950 and the window substrate 700 may be increased by the second ink layer 850. Therefore, the identification mark 950 may not be visible from the outside.

In an embodiment, the identification mark 950 may be formed with a concavo-convex pattern cut in the area where the ink layer 800 and the identification layer 900 overlap (S40). The identification mark 950 may be formed by selectively cutting an area where the first ink layer 830, the second ink layer 850, and the identification layer 900 overlap and form a concavo-convex pattern. The identification mark 950 may be defined by a concavo-convex pattern cut in the thick area where the first ink layer 830, the second ink layer 850, and the identification layer 900 overlap.

In an embodiment, the identification mark 950 may be formed so that the concavo-convex pattern corresponds to a bar code or a quick response (QR) code.

For example, a bar code or QR code may be engraved on the cover window CW to provide information about the cover window CW. When the bar code or QR code is engraved on the cover window CW, ink may be printed on the printing part 730 of the cover window CW, and then a concavo-convex pattern may be cut on the printing part 730 using a laser or the like to form the bar code or QR code.

The area where the first ink layer 830, the second ink layer 850, and the identification layer 900 overlap may have an increased thickness due to the presence of three layers on top of one another. Accordingly, even if the concavo-convex pattern is cut by a laser or the like, the increased thickness may prevent the bar code or QR code from being visible from the outside. The second ink layer 850 and the identification layer 900 may be formed at a position where a bar code or QR code is formed to form the identification mark 950, and may be provided as a cutting area of a concavo-convex pattern for forming the bar code or QR code.

In another embodiment, the printing method may be to print a third ink and a fourth ink onto the window substrate 700. Printing the third ink and the fourth ink on the window substrate 700 may include transferring the third ink to the printing part 730 of the window substrate 700 at a predetermined thickness to form a preliminary transfer area, and transferring the fourth ink to the preliminary transfer area. The fourth ink may be transferred to have a smaller face area than the preliminary transfer area.

The printing plate provided with the third ink may include a concave part. The third ink may be injected into the concave part and absorbed into the pad. In this manner, a preliminary transfer area including an ink layer having a substantially constant thickness may be formed on the window.

The printing plate provided with the fourth ink may include a concave part having a quadrangular shape. The fourth ink may be injected into the concave part and absorbed into the pad. Accordingly, an ink layer having a substantially constant thickness may be formed on the preliminary transfer area.

On the window substrate 700, an area where the third ink is transferred to the preliminary transfer area and an area where an ink layer with the fourth ink transferred on preliminary transfer area may be formed by overlapping of the third and fourth ink layers.

Accordingly, the ink layer formed on the window may include areas having different thicknesses. The area where the third ink and the fourth ink are overlapped and printed may be thicker than areas with one ink layer. Accordingly, even if the identification mark 950 is formed in the area where the third ink and the fourth ink are overlapped and printed, the identification mark 950 may not be visible from the outside.

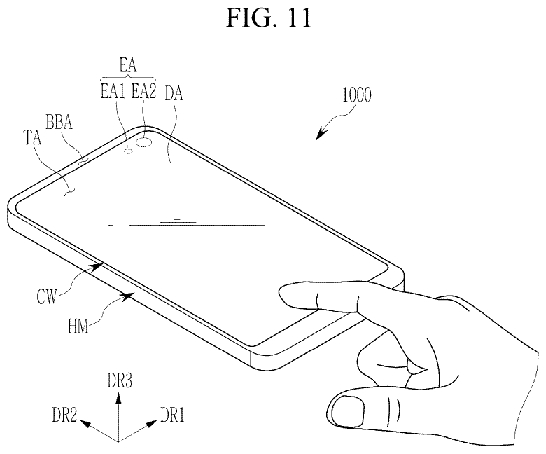

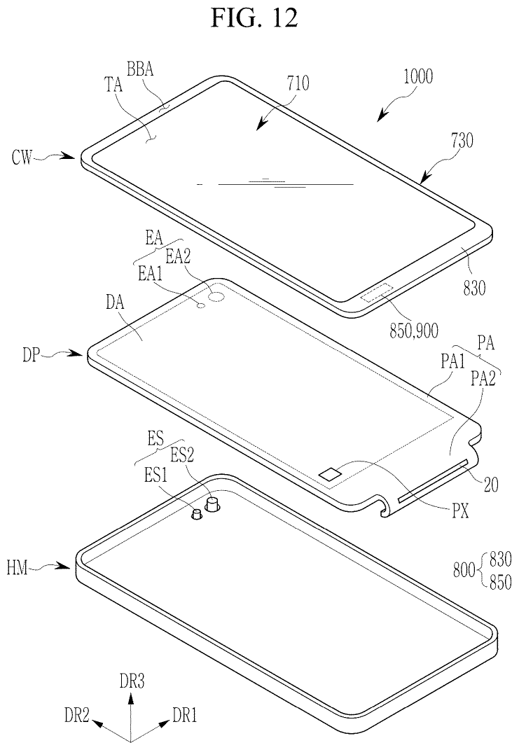

FIG. 11 is a schematic perspective view of the display device, and FIG. 12 is an exploded perspective view of the display device.

Referring to FIG. 11, a display device 1000 represents a device for displaying videos or still images, and it may be used as a display screen for portable electronic devices such as mobile phones, smartphones, tablet personal computers (PC), mobile communication terminals, electronic organizers, electronic books, portable multimedia players (PMP), global positioning systems, or ultra-mobile PCs (UMPC), and also for various products such as televisions, laptops, monitors, advertisement boards, or the Internet of Things (IOT). In addition, the display device 1000 according to an embodiment may be used on wearable devices such as smart watches, watch phones, glasses-type displays, or head mounted displays (HMD). In addition, the display device 1000 according to an embodiment may be used as a dashboard of a vehicle, a center information display (CID) disposed on a center fascia or a dashboard of a vehicle, a room mirror display replacing a side-view mirror of a vehicle, and a display disposed on a rear surface of a front seat for entertainment for a back seat of a vehicle. FIG. 11 illustrates the display device 1000 being used as a smartphone for convenience of description.

The display device 1000 may display images through a display surface parallel to a surface defined in a first direction DR1 and a second direction DR2. The displaying surface for displaying images may correspond to a front surface of the display device 1000, and may correspond to a front surface of a cover window CW. The images may include videos and still images.

In an embodiment, front surfaces (or upper surfaces) and rear surfaces (or lower surfaces) of respective members are defined with reference to the image-displaying direction. The front surface and the rear surface may oppose each other in a third direction DR3, and the directions that are orthogonal to the front surface and the rear surface may be parallel to the third direction DR3. The spacing between the front surface and the rear surface in the third direction DR3 may correspond to a thickness of a display panel in the third direction DR3.

The display device 1000 may sense a user's input applied from the outside. The user input may include various types of external inputs such as touch or movement of a human body of the user, light, heat, or pressure. The user input is shown with the user's hand applied to the front surface. The user input may be provided in various forms, and the display device 1000 may also sense the user input applied to the side surface or rear surface of the display device 1000 depending on the structure of the display device 1000.

Referring to FIGS. 11 and 12, the display device 1000 may include the cover window CW, a housing HM, the display panel DP, and an optical element ES. In an embodiment, the cover window CW and the housing HM may be combined to configure the exterior of the display device 1000.

The cover window CW may include an insulating panel. For example, the cover window CW may be made of glass, plastic, or a combination thereof.

The front surface of the cover window CW may define the front surface of the display device 1000. A transmission area TA may be an optically transparent area. For example, the transmission area TA may be an area with visible ray transmittance of about 80%, 85%, or 90% or more.

A blocking area BBA may define the shape of the transmission area TA. The blocking area BBA may be adjacent to the transmission area TA and surround the transmission area TA. The blocking area BBA may be an area with relatively low light transmittance compared to the transmission area TA. The blocking area BBA may have a predetermined color. The blocking area BBA may overlap a non-display area PA of the display panel DP to block the non-display area PA from being visible from the outside. The blocking area BBA may be defined by an ink layer inserted or colored into a transparent base layer defining the transmission area TA. The cover window CW may be the cover window CW manufactured through the method of manufacturing the cover window described above.

In an embodiment, the cover window CW may include the window part 710 covering the display area DA and the printing part 730 disposed at the edge of the window part 710. The window part 710 may be disposed on the display area DA. The printing part 730 may be a light blocking area BAA that at least partially overlaps the non-display area PA.

In an embodiment, the printing part 730 may include the first ink layer 830 and the second ink layer 850 disposed on the first ink layer 830 and having a smaller face area than the first ink layer 830. The ink layer 800 including the first ink layer 830 and the second ink layer 850 formed on the printing part 730 may be the first ink layer 830 and the second ink layer 850 printed on the cover window CW manufactured according to the method of manufacturing the cover window described with reference to FIGS. 5 to 10 using the printing plate described with reference to FIGS. 1 to 4.

In an embodiment, the identification layer 900 may be disposed on the ink layer 800, and the identification mark may be formed by the identification layer 900. The identification mark may have a concavo-convex pattern engraved on the identification layer 900 and the ink layer 800. For example, the identification mark may be a concavo-convex pattern engraved on a portion of the identification layer 900. The identification mark may be a concavo-convex pattern engraved on the identification layer 900 and a portion of the second ink layer 850. The identification mark may be a concavo-convex pattern engraved on the identification layer 900, the second ink layer 850, and a portion of the first ink layer 830.

The thickness of the second ink layer 850 may be smaller than the thickness of the first ink layer 830. For example, the thickness from the surface of the cover window CW to the surface of the first ink layer 830 may be greater than the thickness from the surface of the first ink layer 830 to the surface of the second ink layer 850. Accordingly, the second ink layer 850 may maintain its shape stably without collapsing on the first ink layer 830.

The identification layer 900 may have a smaller face area than the first ink layer 830. The identification layer 900 may have a face area that is substantially the same as or smaller than the second ink layer 850. For example, the second ink layer 850 may be formed on the first ink layer 830 with a smaller face area than the first ink layer 830, and the identification layer 900 may be formed on the second ink layer 850 with a face area that is substantially the same as or smaller than the second ink layer 850, as shown in FIG. 10.

The identification mark may be disposed in an area where the second ink layer 850 and the identification layer 900 overlap. The identification mark may be disposed in an area where the first ink layer 830, the second ink layer 850, and the identification layer 900 overlap. Accordingly, the identification mark may not be visible from the outside.

The maximum depth of the concavo-convex pattern may be less than the sum of the thickness of the first ink layer 830, the thickness of the second ink layer 850, and the thickness of the identification layer 900. For example, the depth of the concave part of the identification mark at any point of the concavo-convex pattern may be less than the sum of the thickness of the first ink layer 830, the thickness of the second ink layer 850, and the thickness of the identification layer 900. Hence, depth of any portion of the concavo-convex pattern may be less than the sum of the thickness of the first ink layer 830, the thickness of the second ink layer 850, and the thickness of the identification layer 900. Accordingly, the concave part may be formed apart from the surface of the cover window CW. Therefore, the concavo-convex pattern may not be visible from the outside. The maximum depth of the concavo-convex pattern may be less than the sum of the thickness of the second ink layer 850 and the thickness of the identification layer 900.

The display panel DP may include a display pixel PX for displaying an image and a driver 20, and the display pixel PX is disposed in a display area DA and a component area EA. The display panel DP may include the display area DA on which an image is displayed. The display panel DP may include a front surface including the display area DA and a non-display area PA. In an embodiment, the display area DA and the component area EA may be areas where an image is displayed including a pixel, and at the same time, may be areas where a touch sensor is disposed above the pixel in the third direction DR3 to sense an external input.

The transmission area TA of the cover window CW may at least partially overlap the display area DA and the component area EA of the display panel DP.

For example, the transmission area TA may overlap the front surface of the display area DA and the component area EA, or may at least partially overlap the display area DA and the component area EA. Accordingly, the user may view the image through the transmission area TA or provide external input based on the image. However, the present disclosure is not limited thereto. For example, the area where an image is displayed and the area where external input is sensed may be separated.

The non-display area PA of the display panel DP may at least partially overlap the blocking area BBA of the cover window CW. The non-display area PA may be an area covered by the blocking area BBA. The non-display area PA may be adjacent to the display area DA and may surround the display area DA. The non-display area PA does not display images, and a driving circuit or driving wiring for driving the display area DA may be present. The non-display area PA may include a first non-display area PA1 disposed outside the display area DA, and a second non-display area PA2 including the driver 20, connection wiring, and a bending area. In the embodiment of FIG. 12, the first non-display area PA1 is disposed on three sides of the display area DA, and the second non-display area PA2 is disposed on the remaining side of the display area DA.

Part of the non-display area PA of the display panel DP may be curved. Part of the non-display area PA may face the rear surface of the display device 1000, thereby reducing the blocking area BBA visible on the front surface of the display device 1000. The display panel DP may be assembled after disposing the bent second non-display area PA2 on the rear surface of the display area DA.

The display device described above may be applied to a variety of electronic devices. The electronic device according to an embodiment may include the display device described above and may further include modules or devices having other additional functions in addition to the display devices.

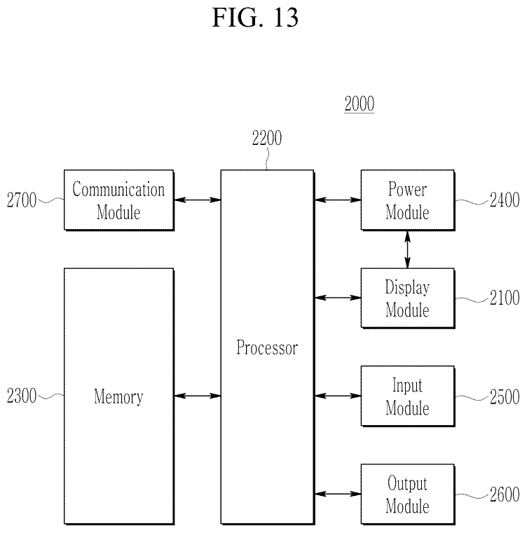

FIG. 13 is a block diagram of the electronic device according to an embodiment. Referring to FIG. 13, the electronic device 2000 may include a display module 2100, a processor 2200, a memory 2300, and a power module 2400. The electronic device 2000 may further include an input module 2500, a non-image output module 2600, and/or a communication module 2700.

The electronic device 2000 may output various information in the form of an image via the display module 2100. When the processor 2200 executes an application stored in the memory 2300, the display module 2100 may provide the user with the visual information provided by the application. The power module 2400 may include a power supply module, such as a power adapter or battery unit, and a power conversion module that converts the power supplied by the power supply module to generate the power required for operation of the electronic device 2000. The input module 2500 may provide input information to the processor 2200 and/or the display module 2100. The non-image output module 2600 may receive non-image information from the processor 2200. Such as sound, haptic, light or other information, and provide it to users. The communication module 2700 is a module responsible for sending and receiving information between the electronic device 2000 and an external device, and may include a receiving part and a transmitting part.

At least one of each of the above-described configurations of the electronic device 2000 may be included within the display device according to the above-described embodiments. Additionally, some of modules that are functionally included within a single module may be included within the display device and others may be provided separately from the display device. For example, the display device may include the display module 2100, and a processor 2200, memory 2300, and power module 2400 may be provided in the form of other devices within the electronic device 2000 other than the display device.

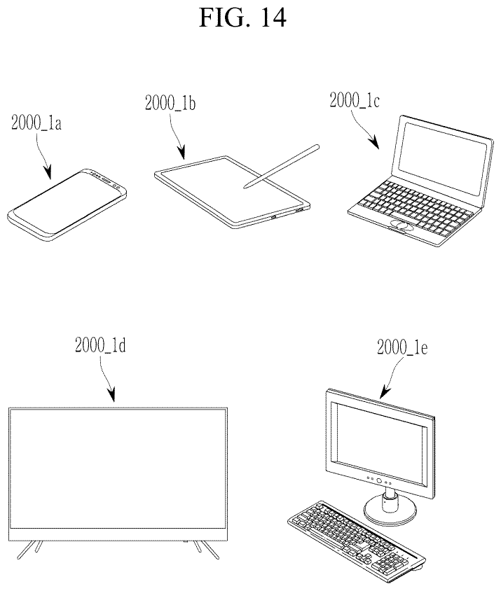

FIGS. 14 to 16 are schematic diagrams of electronic devices according to some embodiments. FIGS. 14 to 16 illustrate examples of various electronic devices with indicating devices according to various embodiments.

FIG. 14 illustrates a smartphone 2000_1a, a tablet PC 2000_1b, a laptop 2000_1c, a TV 2000_1d, and a desk monitor 2000_1e as examples of electronic devices.

The smartphone 2000_1a may include the input module such as a touch sensor and the communication module in addition to the display module 2100.

The smartphone 2000_1a may process information received through the communication module or other input module and display the information through the display module of the display device.

The tablet PC 2000_1b, the laptop 2000_1c, the TV 2000_1d, and the desk monitor 2000_1e also may include the display modules and the input modules similar to the smartphone 2000_1a, and in some cases may further include communication modules.

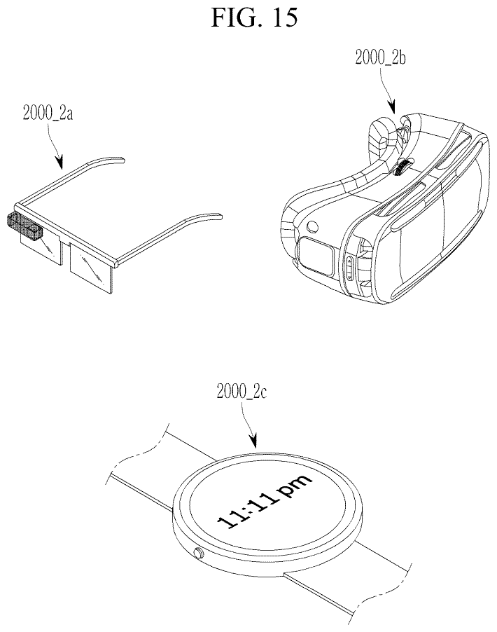

FIG. 15 illustrates an electronic device including the display module applied to a wearable electronic device. The wearable electronic device may include a smart eyewear 2000_2a, a head-mounted display 2000_2b, a smart watch 2000_2c, etc.

The smart glass 2000_2a and the head-mounted display 2000_2b may include the display module that emits a display image and provides it to the user's eyes, thereby providing a virtual reality view or augmented reality view to the user.

The smartwatch 2000_2c may include a biometric sensor as the input device, and may provide biometric information recognized by the biometric sensor to the user through the display module.

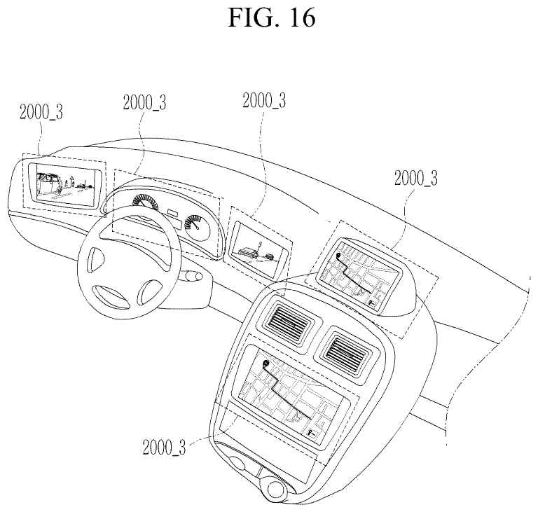

FIG. 16 illustrated an example of the electronic device including the display module applied to a vehicle. For example, the electronic device 2000_3 may be applied to an instrument panel, a center fascia, etc. of the vehicle, or to a center information display (CID) placed on a dashboard of the vehicle, or to a room mirror display that replaces a side mirror.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A printing plate used in pad printing, comprising:
a base substrate having a concave part sunken from a substrate surface,
wherein the concave part includes a first area that is sunken by a first depth from the substrate surface of the base substrate and a second area that is sunken by a second depth from a surface of the first area.

2. The printing plate of claim 1, wherein
the base substrate includes a substrate central part and a substrate peripheral part surrounding the substrate central part
and the concave part is disposed in the substrate peripheral part without extending into the substrate central part.

3. The printing plate of claim 2, wherein
the first area is disposed surrounding the substrate central part in the substrate peripheral part.

4. The printing plate of claim 1, wherein
the first area has a width and an imaginary centerline extending through midpoints of the width, further comprising a concave central part including the imaginary centerline and a predetermined distance to either side of the centerline in the first area and a concave peripheral part surrounding the concave central part,
and the second area is disposed in the concave central part.

5. The printing plate of claim 4, wherein
the second area has a quadrangular shape.

6. The printing plate of claim 1, wherein
the first depth of the first area from the substrate surface is greater than the second depth of the second area from the surface of the first area.

7. The printing plate of claim 1, wherein
the second depth is at least 4 μm and no greater than 10 μm.

8. A electronic device, comprising:
a display device including a display panel including a display area in which an image is displayed and a cover window including a window part covering the display area and a printing part disposed at the edge of the window part,
wherein the printing part includes an ink layer, including a first ink layer and a second ink layer disposed on the first ink layer and having a smaller face area than the first ink layer, and
an identification mark formed in an identification layer disposed on the ink layer, wherein the identification mark has a concavo-convex pattern engraved on the identification layer and the second ink layer.

9. The electronic device of claim 8, wherein
the thickness of the second ink layer is smaller than the thickness of the first ink layer.

10. The electronic device of claim 8, wherein
the identification layer has a smaller face area than the first ink layer.

11. The electronic device of claim 8, wherein
the identification mark is disposed in an area where the second ink layer and the identification layer overlap.

12. The electronic device of claim 8, wherein
a depth at any portion of the concavo-convex pattern is smaller than the sum of the thickness of the first ink layer, the thickness of the second ink layer, and the thickness of the identification layer.

13. A method of manufacturing a cover window, comprising:
preparing a printing plate, including a base substrate having a concave part sunken from a substrate surface, wherein the concave part includes a first area that is sunken by a first depth from the substrate surface of the base substrate and a second area that is sunken by a second depth from a surface of the first area;
forming an ink layer by injecting a first ink into the printing plate and transferring the injected first ink onto a window substrate using a pad;
forming an identification layer on the ink layer; and
forming an identification mark by cutting an area where the ink layer and the identification layer overlap in a concavo-convex pattern.

14. The method of manufacturing the cover window of claim 13, wherein the forming of the ink layer includes injecting the first ink into the first area and the second area of the concave part.

15. The method of manufacturing the cover window of claim 14, wherein the forming of the ink layer includes forming a first ink layer and a second ink layer with the first ink injected into the first area and the second area.

16. The method of manufacturing the cover window of claim 15, wherein the forming of the ink layer includes forming the second ink layer to be thinner than the first ink layer.

17. The method of manufacturing the cover window of claim 15, wherein
the forming of the identification layer includes printing the identification ink on the second ink layer having a smaller face area than the first ink layer.

18. The method of manufacturing the cover window of claim 13, wherein
the forming of the ink layer includes
injecting the first ink into the concave part;
transferring the first ink to the window substrate and drying the first ink;
injecting the second ink into the concave part; and
transferring the second ink to the dried first ink and drying the second ink.

19. The method of manufacturing the cover window of claim 13, wherein
the forming of the identification mark includes forming the concavo-convex pattern to have a depth smaller than the sum of the thickness of the ink layer and the thickness of the identification layer.

20. The method of manufacturing the cover window of claim 13, wherein
the forming of the identification mark comprises forming the concavo-convex pattern to correspond to a bar code or a quick response (QR) code.
